(19) United States
(12) Patent Application Publication
(10) Pub. No.: US 2014/0018058 A1
(43) Pub. Date: Jan. 16, 2014

(54) SYSTEMS AND METHODS INVOLVING DEVICE INTERACTION

(71) Applicant: Gregory A. Dunko, Cary, NC (US)

(72) Inventor: Gregory A. Dunko, Cary, NC (US)

(73) Assignee: HTC Corporation, Taoyuan City (TW)

(21) Appl. No.: 13/548,512

(22) Filed: Jul. 13, 2012

(51) Int. Cl. H04W 80/00; G05B 23/02

(52) U.S. Cl. 455/419; 340/3.1

(57) ABSTRACT

Systems and methods with device interaction are provided. In this regard, a representative system for interacting with a secondary device includes: an electronic device selectively operative in a first mode and a second mode, the electronic device having a device detection system operative to detect presence of the secondary device and a mode selection system operative to automatically alter operation of the electronic device from the first mode to the second mode based, at least in part, on the detected presence of the secondary device.

### TECHNICAL FIELD

The present disclosure generally relates to electronic devices.

### BACKGROUND

Electronic devices such as mobile phones, for example, are capable of exhibiting various modes of operations. Each mode typically is associated with a different user interface that is often provided by an application. By way of example, a smartphone may exhibit a mode associated with the playing of music that displays information about a song that is being played. In another mode, the smartphone may display a map corresponding to the location of the smartphone. Unfortunately, each of the modes is initiated in response to user activation of the associated application.

### SUMMARY

Systems and methods with device interaction are provided. Briefly described, one embodiment, among others, is a system for interacting with a secondary device comprising: an electronic device selectively operative in a first mode and a second mode, the electronic device having a device detection system operative to detect presence of the secondary device and a mode selection system operative to automatically alter operation of the electronic device from the first mode to the second mode based, at least in part, on the detected presence of the secondary device.

Another embodiment is a method for interacting with a secondary device comprising: operating an electronic device in a first mode, in which a first user interface is displayed; detecting, at the electronic device, presence of the secondary device; and automatically altering operation of the electronic device to a second mode based, at least in part, on the detected presence of the secondary device such that a second user interface is displayed.

Another embodiment is a method for interacting with a secondary device comprising: operating an electronic device in a first mode; detecting, at the electronic device, presence of the secondary device; and automatically altering operation of the electronic device to a second mode based, at least in part, on the detected presence of the secondary device.

Other systems, methods, features, and advantages of the present disclosure will be or may become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram of an example embodiment of a system involving device interaction.

FIG. 2 is a flowchart depicting an example embodiment of a method that may be performed by the embodiment of FIG. 1.

FIG. 3 is a schematic diagram of another example embodiment of a system.

FIG. 4 is a schematic diagram showing detail of a possible implementation of the electronic device of FIG. 3.

FIG. 5 is a schematic diagram of another example embodiment of a system showing the altering of modes of the electronic device.

FIG. 6 is a flowchart depicting functionality that may be performed by an example embodiment of a system.

### DETAILED DESCRIPTION

Having summarized various aspects of the present disclosure, reference will now be made in detail to that which is illustrated in the drawings. While the disclosure will be described in connection with these drawings, there is no intent to limit the scope of legal protection to the embodiment or embodiments disclosed herein. Rather, the intent is to cover all alternatives, modifications and equivalents included within the spirit and scope of the disclosure as defined by the appended claims.

In this regard, systems and methods involving device interaction are provided. In some embodiments, a secondary device (i.e., an inanimate object) provides a stimulus for altering the mode of operation of an electronic device. This may be accomplished by the secondary device communicating information to the electronic device that informs the electronic device of its presence. Responsive to the information, the electronic device may alter a current mode of operation. In some embodiments, the mode of operation of the electronic device may be altered to complement functionality provided by the device. For instance, the secondary device may be a bicycle and the mode of the electronic device may be altered to display a moving map function, which may be desirable to a user of the bicycle. In some embodiments, the altered mode may be one that is previously selected by the user as being associated with the secondary device.

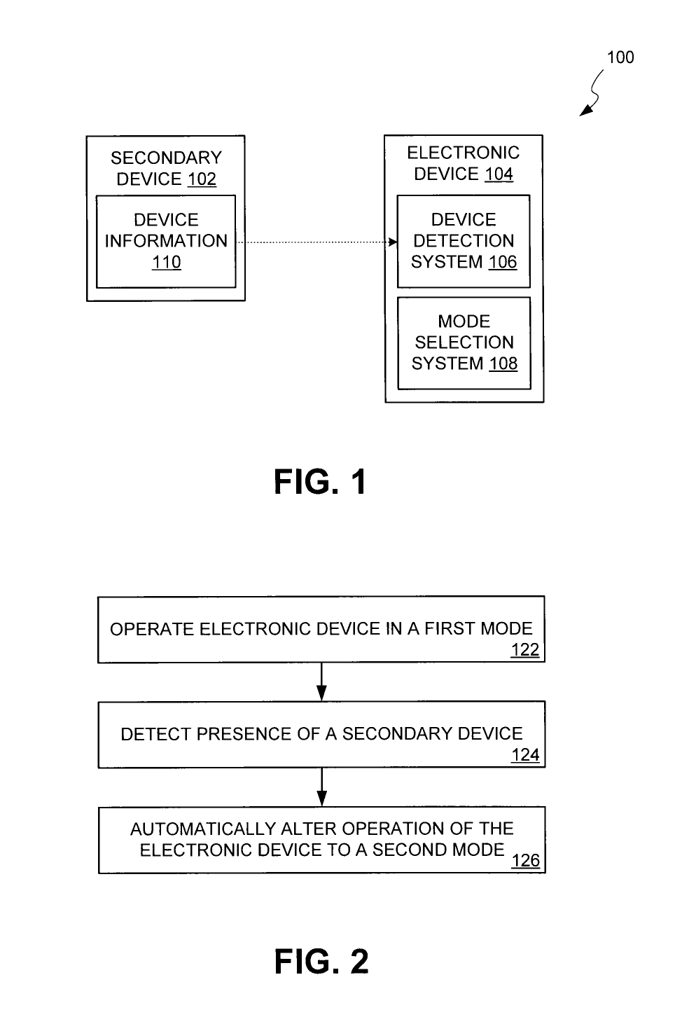

FIG. 1 is a schematic diagram of an example embodiment of a system involving device interaction. As shown in FIG. 1, system 100 includes a secondary device 102 and an electronic device 104. The electronic device, which may be provided in various configurations (such as a smartphone, for example), incorporates a device detection system 106 and a mode selection system 108. Secondary device 102 includes device information 110.

In operation, the secondary device provides device information 110, which is input to device detection system 106. The device detection system interprets the device information and may interact with the mode selection system to facilitate altering a mode of operation of the electronic device. In this embodiment, the device detection system attempts to identify attributes of the secondary device from the device information so enable selection of an appropriate mode of operation of the electronic device.

Responsive to information provided by the device detection system, the mode selection system may alter the mode of operation of the electronic device. In some embodiments, this may involve launching of an application that may be intuitively associated with the device. For instance, if the secondary device is a skateboard, the mode selection system may launch a music player application so that the user may listen to music while skateboarding. Additionally, or alternatively, the new mode may have a simplified User Interface (UI) that is optimized for use while on a skateboard. Moreover, in some embodiments, an application that is to be launched may be predetermined by user.

FIG. 2 is a flowchart depicting an example embodiment of a method that may be performed by the embodiment of FIG. 1. As shown in FIG, 1, the method may be construed as beginning at block 122, in which an electronic device is operated in a first mode. In block 124, presence of a secondary device is detected by the electronic device. For instance, device information associated with the secondary device may be received at the electronic device. Thereafter, such as depicted in block 126, operation of the electronic device is automatically altering to a second mode based, at least in part, on the device information.

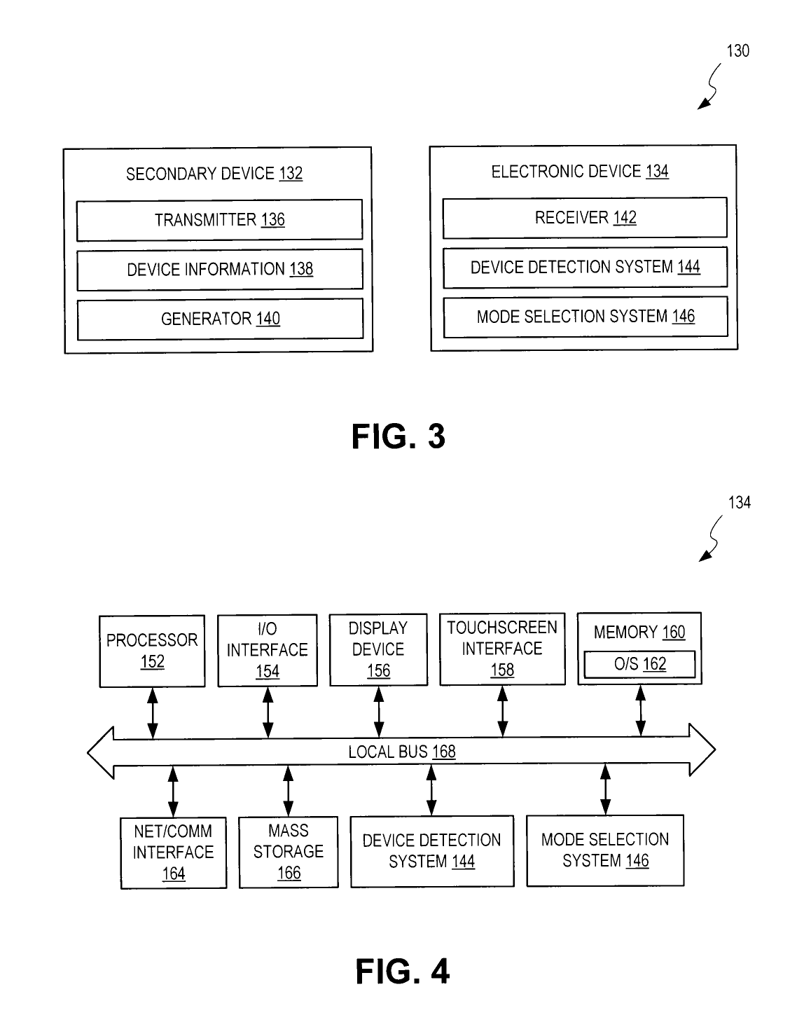

FIG. 3 is a schematic diagram of another example embodiment of a system. As shown in FIG. 3, system 130 includes a secondary device 132 and an electronic device 134. Secondary device 132 includes a transmitter 136, device information 138, and a generator 140. The generator is configured to provide an electrical output that is able to power the transmitter, as well as any other component that may be implemented for transmitting the device information. By way of example, this may include power for an associated micro-processor and memory (both of which are not depicted) that may control the operations of the transmitter.

In this embodiment, the generator converts a mechanical input (e.g., pedaling) provided by a user of the secondary device to electricity (e.g., 5.5V). For instance, a rotor of the generator may be mechanically coupled to rotating component of the secondary device (e.g., an axle).

The electricity is routed to the transmitter, which transmits the device information. It should be noted that the transmitter may be configured for transmitting the device information in various manners. In this embodiment, the transmitter is a Bluetooth transmitter. In other embodiments, the transmitter may support NFC, WiFi, Ethernet and/or other transmission protocols.

The electronic device incorporates a receiver 142, a device detection system 144 and a mode selection system 146. The receiver, which is a Bluetooth receiver in this embodiment, is operative to receive device information 138. The device detection system interprets the device information and may interact with the mode selection system to facilitate altering a mode of operation of the electronic device. Notably, the device information in this embodiment uniquely identifies the secondary device (e.g., type, style and possibly Bluetooth ID or serial number). As such, the device detection system associates the identified secondary device with an appropriate mode of operation of the electronic device. In some embodiments, the secondary device 102 and the electronic device 104 may be paired for further communication or integration. Notably, the pairing may be initiated by the secondary device 102 or the electronic device 104.

Responsive to information provided by the device detection system, the mode selection system may alter the mode of operation of the electronic device. Notably, in some embodiments, it may be inappropriate to alter the current mode of operation, such as when the electronic device is a smartphone and the user is engaged in a phone call, for example. However, if considered appropriate, the mode of operation may be altered by the mode selection system. Note that the mode of operation may include a UI change more suitable for interaction while using the secondary device. For example, on a bicycle, the UI may use a larger font, operate in landscape, disable auto-screen off, etc. When the mode of operation change includes playing music, “customized” content (e.g., bicycle riding music) may be activated, among others.

FIG. 4 is a schematic diagram of a portion of electronic device 134 of FIG. 3. As shown in FIG. 4, electronic device 134 includes a processing device (processor) 152, input/output interfaces 154, a display device 156, a touchscreen interface 158, a memory 160, operating system 162, a network/communication interface 164, and a mass storage 166, with each communicating across a local data bus 168. Additionally, the system incorporates device detection system 144 and mode selection system 146.

The processing device 152 may include a custom made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory 160 may include any one of a combination of volatile memory elements (e.g., random-access memory (RAM, such as DRAM, and SRAM, etc.)) and nonvolatile memory elements. The memory typically comprises native operating system 162, one or more native applications, emulation systems, or emulated applications for any of a variety of operating systems and/or emulated hardware platforms, emulated operating systems, etc. For example, the applications may include application specific software which may comprise some or all the components of the system. In accordance with such embodiments, the components are stored in memory and executed by the processing device. Note that although depicted as not being resident in memory 160, device detection system 144 and mode selection system 146 may be stored in memory 160.

Touchscreen interface 158 is configured to detect contact within the display area of the display 156 and provides such functionality as on-screen buttons, menus, keyboards, soft-keys, etc., that allows users to navigate user interfaces by touch.

One of ordinary skill in the art will appreciate that the memory may, and typically will, comprise other components which have been omitted for purposes of brevity. Note that in the context of this disclosure, a non-transitory computer-readable medium stores one or more programs for use by or in connection with an instruction execution system, apparatus, or device.

With further reference to FIG. 4, network/communication interface 164 comprises various components used to transmit and/or receive data over a networked environment, such as receiver 142 of FIG. 3. By way of example, such components may include a wireless communications interface. When such components are embodied as an application, the one or more components may be stored on a non-transitory computer-readable medium and executed by the processing device.

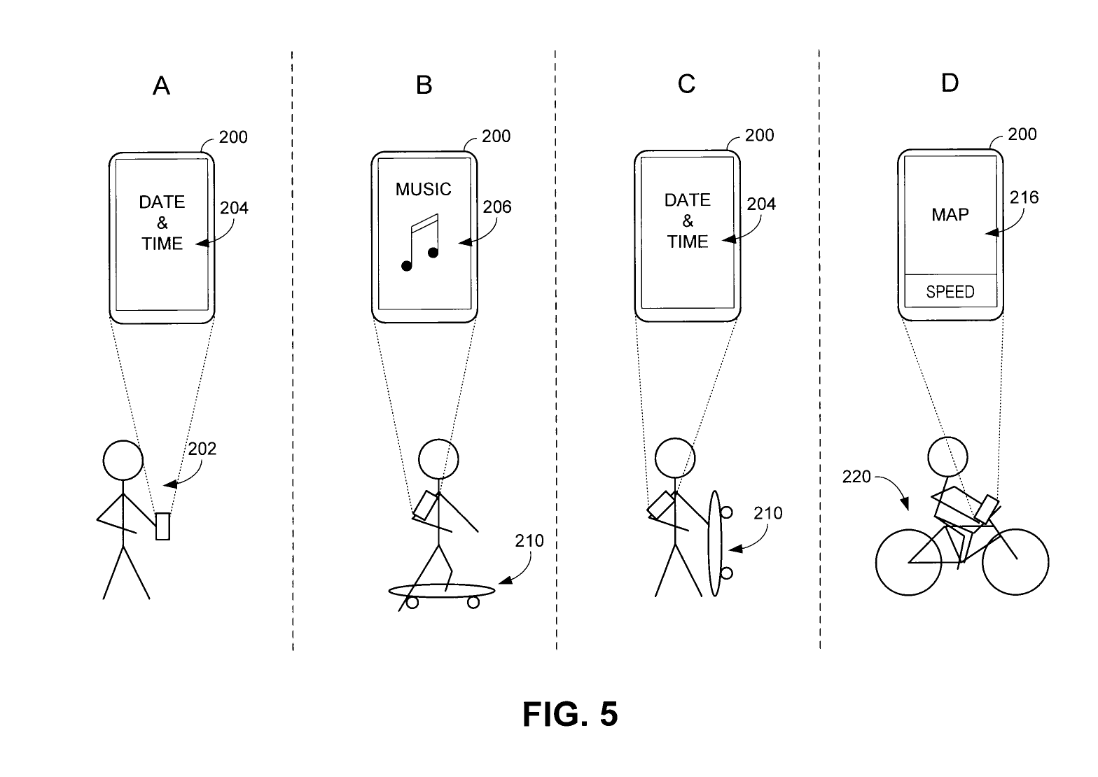

FIG. 5 is a schematic diagram of another example embodiment of a system showing the altering of modes of the electronic device. As shown in FIG. 5, an electronic device 200 is being operated by a user 202. In this embodiment, electronic device 200 is a smartphone.

In the first scenario (A), the user is walking with the electronic device. This results in the electronic device operating in a first mode 204, in which a default user interface (UI) is displayed to the user.

In the second scenario (B), the user is in a vicinity of a secondary device 210. Here, secondary device 210 is configured as a skateboard and the user is riding the skateboard. In scenario B, device information (not shown) has been transmitted from secondary device 210 to electronic device 200. Responsive to the device information, the electronic device alters operation such that a second mode 206 is exhibited. In this example, the second mode is associated with the execution of a music application. Notably, if this were the first time the electronic device detected secondary device 210 (or a secondary device of similar type), a user may be provided for the user to associate a desired mode of operation with this secondary device so that the electronic device will operate in the pre-selected mode in response to detection of the secondary device. The information corresponding to the secondary device and selected mode may be stored by the electronic device.

In this embodiment, secondary device 210 is configured to transmit the device information responsive to use, such as responsive to movement of the device causing an onboard generator to power an associated transmitter.

In the third scenario (C), the mode of the electronic device changes back to mode 204 (i.e., the mode exhibited during scenario A). The electronic device exhibits this behavior responsive to the discontinuation of receipt of the device information. Notably, in this embodiment, device information is only transmitted when the device is being used in a manner that generates electricity. In this case, the device is being carried by the user, thus, no electricity is generated by the onboard generator. In other embodiments, such as those in which presence is detected without the use of continuously transmitted device information during use, change of mode of operation may be the result of the electronic device no longer detecting the presence of the secondary device (e.g., a discontinuance in communication between the electronic device and the secondary device).

In the fourth scenario (D), the mode of the electronic device changes to a third mode 216 associated with a different secondary device. Specifically, secondary device 220 is a bicycle, which is configured to transmit corresponding device information. Responsive to receiving the device information associated with the bicycle, the electronic device alters the mode of operation to display a map and an indication of speed. On a bicycle, some options may include, but are not limited to: auto answer, automatic use of Text-to-speech and Speech-to-text, simplified UI, etc.

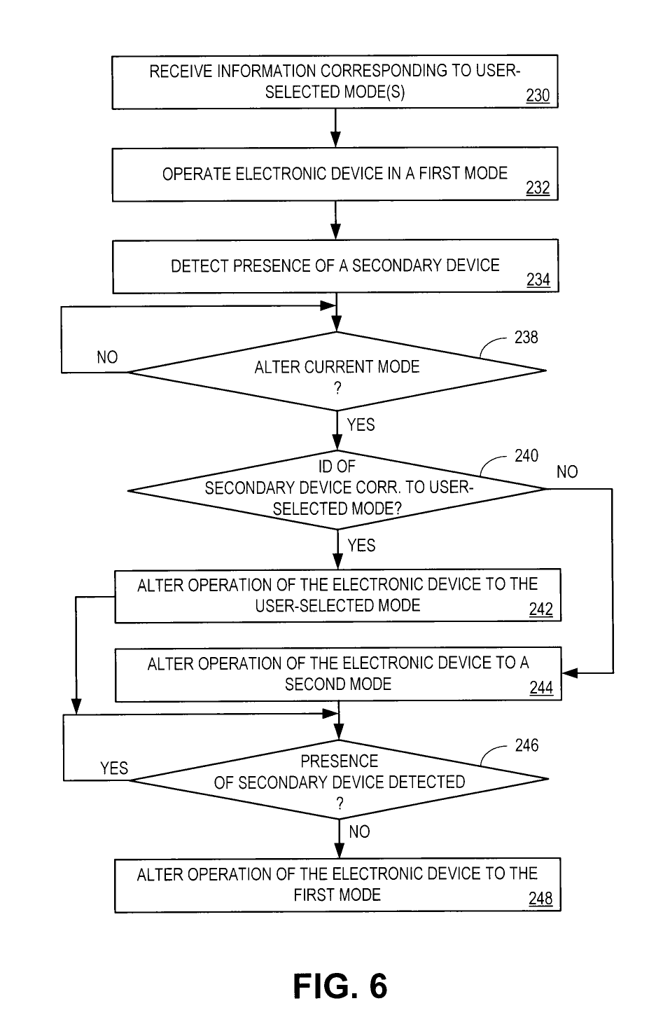

It should be noted that one or more of the modes that the electronic device exhibited in the example of FIG. 5 may be selected by the user. For instance, a user may desire to associate a particular mode of operation with a particular secondary device (or type of secondary device). Functionality of one such embodiment is shown in FIG. 6.

FIG. 6 is a flowchart depicting functionality that may be performed by another example embodiment of a system. As shown in FIG. 6, the functionality (or method) may be construed as beginning at block 230, in which information corresponding to one or more user-selected modes is received. In some embodiments, this may include information identifying a secondary device and the mode of operation that is to be exhibited responsive to detection of that secondary device.

In block 232, the electronic device is operated in a first mode, which may or may not be a user selected mode and, in block 234, presence of a secondary device is detected (e.g., a communications connection may be established). By way of example, the secondary device may include an electronic tag that may emit information and/or may be sensed by the electronic device. Thereafter, a determination is made as to whether a current mode of operation of the electronic device is to be altered (block 238). Notably, this may include determining whether the current use of the electronic device exhibits a higher priority than the mode associated with newly received device information. By way of example, if a user is currently using a particular functionality of an electronic device, it may not be desirable to alter the mode of operation until that functionality is no longer being used. If it is determined in block 238 that the mode may be altered, the process proceeds to block 240. However, if the mode may not be altered, the process returns to block 238.

In block 240, a determination is made as to whether the detected secondary device corresponds to a user-selected mode. For instance, if device information received at the electronic device does correspond to a user-selected mode, the process proceeds to block 242, in which operation of the electronic device is altered to the user-selected mode. However, if not, the process proceeds to block 244, in which operation of the device may be altered to a second mode. It should be noted that selection of the second mode may be based, at least in part, on information contained in the device information (such as an identity and/or attributes of the device).

Following block 244 (or, alternatively, block 242), the process proceeds to block 246, in which a determination is made as to whether presence of the secondary device is still detected. For instance, the electronic device may determine that the device information has discontinued if the transmission of the device information has terminated or the electronic device has moved out of reception range.

Regardless of the manner in which this determination is made, in block 248, the mode of operation of the electronic device is altered back to the first mode responsive to the presence of the secondary device no longer being detected. However, if the presence is still detected, the process may return to block 246 such that the electronic device exhibits the second mode of operation.

If embodied in software, it should be noted that each block depicted in the flowchart of FIG. 4 (or any of the other flowcharts) represents a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system. The machine code may be converted from the source code, etc. If embodied in hardware, each block may represent a circuit or a number of interconnected circuits to implement the specified logical function(s). Additionally, although the flowcharts show specific orders of execution, it is to be understood that the orders of execution may differ.

It should be emphasized that the above-described embodiments are merely examples of possible implementations. Many variations and modifications may be made to the above-described embodiments without departing from the principles of the present disclosure. By way of example, the systems described may be implemented in hardware, software or combinations thereof. All such modifications and variations are intended to be included herein within the scope of this disclosure and protected by the following claims.

At least the following is claimed:

1. A system for interacting with a secondary device, the system comprising:
an electronic device selectively operative in a first mode and a second mode, the electronic device having a device detection system operative to detect presence of the secondary device and a mode selection system operative to automatically alter operation of the electronic device from the first mode to the second mode based, at least in part, on the detected presence of the secondary device.

2. The system of claim 1, wherein the electronic device is further operative to receive a user input designating the second mode and associating the second mode with the secondary device such that, responsive to detection of the presence of the secondary device, the mode selection system automatically alters operation of the electronic device from the first mode to the second mode.

3. The system of claim 2, wherein the electronic device has a Bluetooth receiver operative to receive the device information.

4. The method of claim 1, wherein the electronic device is a smartphone.

5. The system of claim 1, wherein:
the electronic device further comprises a display operative to display a user interface; and
the user interface displayed during the first mode is different from the user interface displayed during the second mode.

6. A method for interacting with a secondary device comprising:
operating an electronic device in a first mode, in which a first user interface is displayed;
detecting, at the electronic device, presence of the secondary device; and
automatically altering operation of the electronic device to a second mode based, at least in part, on the detected presence of the secondary device such that a second user interface is displayed.

7. The method of claim 6, further comprising altering the operation of the electronic device back to the first mode responsive to the secondary device no longer being detected by the electronic device.

8. A method for interacting with a secondary device comprising:
operating an electronic device in a first mode;
detecting, at the electronic device, presence of the secondary device; and
automatically altering operation of the electronic device to a second mode based, at least in part, on the detected presence of the secondary device.

9. The method of claim 8, wherein the electronic device is a smartphone.

10. The method of claim 8, wherein operating the electronic device further comprises operating the electronic device in a vicinity of the secondary device.

11. The method of claim 8, wherein operating the electronic device further comprises receiving device information identifying the secondary device.

12. The method of claim 11, wherein receiving device information further comprises receiving the device information via wireless communication.

13. The method of claim 11, wherein, in automatically altering operation of the electronic device, the second mode is based, at least in part, on an identity of the secondary device.

14. The method of claim 13, further comprising altering the operation of the electronic device back to the first mode responsive to device information no longer being received by the electronic device.

15. The method of claim 8, wherein automatically altering operation of the electronic device comprises automatically launching an application resident on the electronic device.

16. The method of claim 8, wherein automatically altering operation of the electronic device comprises automatically altering a user interface of the electronic device.

17. The method of claim 8, further comprising enabling a user of the electronic device to associate a user-selectable mode of operation with the device such that the second mode is user selectable.

18. The method of claim 8, further comprising altering the operation of the electronic device back to the first mode.

19. The method of claim 18, wherein altering the operation of the electronic device back to the first mode is performed responsive to presence of the secondary device no longer being detected by the electronic device.

20. The method of claim 8, further comprising powering electrical requirements of the device, at least in part, via user interaction with the secondary device.
